(19) United States
(12) Patent Application Publication
(10) Pub. No.: US 2017/0169425 A1
(43) Pub. Date: Jun. 15, 2017

(54) SELECTIVE ENCRYPTION OF TRANSACTIONAL INFORMATION FOR DIFFERENT PARTICIPANTS OF AN ELECTRONIC TRANSACTION

(71) Applicant: PAYPAL, INC., San Jose, CA (US)

(72) Inventor: Max Edward Metral, Brookline, MA (US)

(21) Appl. No.: 14/966,080

(22) Filed: Dec. 11, 2015

(51) Int. Cl. G06Q 20/38; G06F 21/62; G06Q 10/08; H04L 29/06

(52) U.S. Cl. CPC G06Q 20/3829; H04L 63/0442; H04L 63/0471; G06F 21/6209; G06Q 10/083; G06Q 2220/00

(57) ABSTRACT

Transactional information regarding a transaction to be performed by a plurality of parties is obtained. For each party, respective privileges for viewing different portions of the transactional information are determined. Each party is restricted to view only the portion of the transactional information to which the party has the privilege. A plurality of unique public keys is received for the parties, each party having its corresponding unique public key. For each party, the portion of the transactional information that the party is privileged to view is encrypted. The encryption is performed using the respective unique public key corresponding to the party.

### BACKGROUND

Field of the Invention

The present invention generally relates to systems and methods for performing electronic cryptography.

Related Art

Online transactions are becoming more and more prevalent, with an ever-increasing number of online entities that may or may not have a physical real world counterpart. Furthermore, the services offered by these online entities have been improving as well. The popularity of online transactions is partially attributable to the ease and convenience of making a transaction online instead of at a physical location. With more and more transactions being conducted online, electronic information security has become a significant concern. For example, when shopping online, the user typically needs to provide transactional information (e.g., item specifics or the user's personal information such as name, address, or credit card number) that gets sent to many participants of the transaction, which may include store clerks, warehouses, shippers, delivery services, payment processors, etc. However, not all parties in the transaction chain necessarily need this information in its entirety. The more parties that receive the transactional information, the greater the risk that one of the parties may inadvertently (or even knowingly in some cases) expose the information to people who perpetrate fraud. Existing electronic information security schemes have not sufficiently addressed this issue.

Therefore, although existing systems and methods of providing electronic information security are generally adequate for their intended purposes, they have not been entirely satisfactory in every aspect. What is needed is an enhanced electronic information security scheme that allows each party in a transaction chain to have access only to transactional information that is actually needed for the party to perform its intended task, while hiding the rest of the transactional information from that party.

### BRIEF DESCRIPTION OF THE FIGURES

FIG. 1 is block diagram of a networked system suitable for conducting electronic online transactions according to various aspects of the present disclosure.

FIG. 2 is a simplified block diagram illustrating a system of performing electronic cryptography according to various aspects of the present disclosure.

FIG. 3 is a simplified block diagram illustrating another system of performing electronic cryptography according to various aspects of the present disclosure.

FIG. 4 is a flowchart of a method of generating cross-platform tokens according to various aspects of the present disclosure.

FIG. 5 is a diagram illustrating an example cloud computing architecture according to various aspects of the present disclosure.

FIG. 6 is a block diagram of a computer system suitable for implementing one or more components in FIG. 1 according to various aspects of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

It is to be understood that the following disclosure provides many different embodiments, or examples, for implementing different features of the present disclosure. Specific examples of components and arrangements are described below to simplify the present disclosure. These are, of course, merely examples and are not intended to be limiting. Various features may be arbitrarily drawn in different scales for simplicity and clarity.

Online transactions are becoming more and more prevalent, with an ever-increasing number of online entities that may or may not have a physical real world counterpart. Furthermore, the services offered by these online entities have been improving as well. The popularity of online transactions is partially attributable to the ease and convenience of making a transaction online instead of at a physical location. Unfortunately, the popularity of online transactions has also led to an increase in online fraud activities. For example, in a common online transactions scenario, a plurality of different participants involved in the transaction may each need to perform a task in order to complete the transaction. In some examples, the online transaction may involve shipping of one or more items from a sender to a recipient, which involves parties such as store clerks, warehouse personnel, shippers, delivery services, etc. In some other examples, the online transaction may be a financial transaction where one or more electronic documents need to be processed by a plurality of different parties, where each party processes a respective portion of the document before the document gets sent to the next party.

Traditionally, in either of these above scenarios, each party involved in the transaction may have access to all the transactional information in its entirety, or at least have access to more transactional information than it needs to perform its intended task. However, opening up the transactional information to parties who do not necessarily need it may increase exposure to fraud. For example, any of the parties along a transactional chain may become a weak link in terms of security, and hackers or other fraud perpetrators may penetrate the transactional chain through the weak link and thereafter steal sensitive transactional information such as a user's credit card numbers, addresses, birth date, social security number, or other identity-related information.

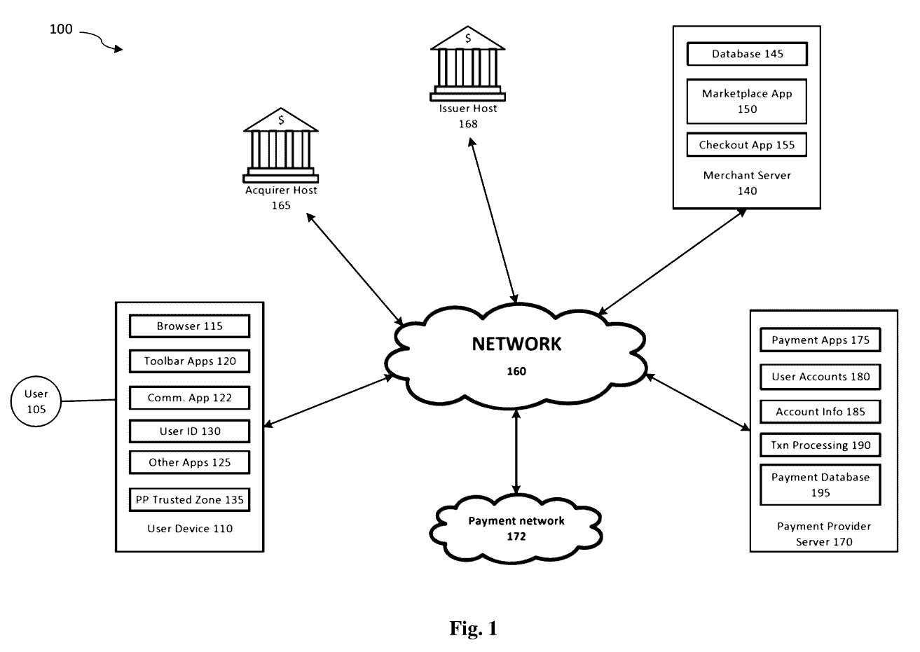

To enhance the information security associated with online transactions, the present disclosure implements an electronic cryptography such that each portion of the transactional information is encrypted specifically for those parties involved in the transaction that actually need or are authorized to have that information, while hiding information from the parties that do not need or have authorization to have it. The various aspects of the present disclosure will now be discussed in more detail below with reference to FIGS. 1-6.

FIG. 1 is block diagram of a networked system suitable for conducting electronic online transactions according to an embodiment. Networked system 100 may comprise or implement a plurality of servers and/or software components that operate to perform various payment transactions or processes. Exemplary servers may include, for example, stand-alone and enterprise-class servers operating a server OS such as a MICROSOFT® OS, a UNIX® OS, a LINUX® OS, or other suitable server-based OS. It can be appreciated that the servers illustrated in FIG. 1 may be deployed in other ways and that the operations performed and/or the services provided by such servers may be combined or separated for a given implementation and may be performed by a greater number or fewer number of servers. One or more servers may be operated and/or maintained by the same or different entities.

The system 100 may include a user device 110, a merchant server 140, a trusted party server 170, an acquirer host 165, an issuer host 168, and a payment network 172 that are in communication with one another over a network 160. In some embodiments, the trusted party server 170 may be maintained by a payment service provider, such as PayPal, Inc. of San Jose, Calif. A user 105, such as a consumer, may utilize user device 110 to perform an electronic transaction using trusted party server 170. For example, user 105 may utilize user device 110 to visit a merchant's web site provided by merchant server 140 or the merchant's brick-and-mortar store to browse for products offered by the merchant. Further, user 105 may utilize user device 110 to initiate a payment transaction, receive a transaction approval request, or reply to the request. Note that transaction, as used herein, refers to any suitable action performed using the user device, including payments, transfer of information, display of information, etc. Although only one merchant server is shown, a plurality of merchant servers may be utilized if the user is purchasing products from multiple merchants. In other embodiments, the trusted party server may be a party that provides privacy service outside of the payment context.

User device 110, merchant server 140, trusted party server 170, acquirer host 165, issuer host 168, and payment network 172 may each include one or more electronic processors, electronic memories, and other appropriate electronic components for executing instructions such as program code and/or data stored on one or more computer readable mediums to implement the various applications, data, and steps described herein. For example, such instructions may be stored in one or more computer readable media such as memories or data storage devices internal and/or external to various components of system 100, and/or accessible over network 160. Network 160 may be implemented as a single network or a combination of multiple networks. For example, in various embodiments, network 160 may include the Internet or one or more intranets, landline networks, wireless networks, and/or other appropriate types of networks.

User device 110 may be implemented using any appropriate hardware and software configured for wired and/or wireless communication over network 160. For example, in one embodiment, the user device may be implemented as a personal computer (PC), a smart phone, a smart phone with additional hardware such as NFC chips, BLE hardware etc., wearable devices with similar hardware configurations such as a gaming device, a Virtual Reality Headset, or that talk to a smart phone with unique hardware configurations and running appropriate software, laptop computer, and/or other types of computing devices capable of transmitting and/or receiving data, such as an iPad™ from Apple™.

User device 110 may include one or more browser applications 115 which may be used, for example, to provide a convenient interface to permit user 105 to browse information available over network 160. For example, in one embodiment, browser application 115 may be implemented as a web browser configured to view information available over the Internet, such as a user account for online shopping and/or merchant sites for viewing and purchasing goods and services. User device 110 may also include one or more toolbar applications 120 which may be used, for example, to provide client-side processing for performing desired tasks in response to operations selected by user 105. In one embodiment, toolbar application 120 may display a user interface in connection with browser application 115.

User device 110 also may include other applications to perform functions, such as email, texting, voice and IM applications that allow user 105 to send and receive emails, calls, and texts through network 160, as well as applications that enable the user to communicate, transfer information, make payments, and otherwise utilize a digital wallet through the trusted party as discussed herein.

User device 110 may include one or more user identifiers 130 which may be implemented, for example, as operating system registry entries, cookies associated with browser application 115, identifiers associated with hardware of user device 110, or other appropriate identifiers, such as used for payment/user/device authentication. In one embodiment, user identifier 130 may be used by a payment service provider to associate user 105 with a particular account maintained by the trusted party. A communications application 122, with associated interfaces, enables user device 110 to communicate within system 100. In conjunction with user identifiers 130, user device 110 may also include a secure zone 135 owned or provisioned by the payment service provider with agreement from device manufacturer. The secure zone 135 may also be part of a telecommunications provider SIM that is used to store appropriate software by the payment service provider capable of generating secure industry standard payment credentials as a proxy to user payment credentials based on user 105's credentials/status in the trusted parties system/age/risk level and other similar parameters.

User device 110 may install and execute a payment application received from the payment service provider to facilitate payment processes. The payment application may allow a user to send payment transaction requests to the payment service provider. In particular, the payment application may authenticate user 105 before making payments. In an embodiment, the payment application may implement automatic authentication of the user 105 when the user 105 is at certain payment locations. The payment application in conjunction with the payment service provider may also provide proxies for user's credentials and funding instrument (e.g., payment and identity proxies for transaction) within secure zone 135 to be used with/without further authentication with payment service provider depending on the transaction or payment situation. The payment application may also receive relevant payment and identity proxies from proximity based ancillary systems such as a Bluetooth beacon installed in the merchant's premises in association with the payment service provider for the purpose of processing transactions or providing value added services to the user.

Merchant server 140 may be maintained, for example, by a merchant or seller offering various products and/or services. The merchant may have a physical point-of-sale (POS) store front. The merchant may be a participating merchant who has a merchant account with the payment service provider. Merchant server 140 may be used for POS or online purchases and transactions. Generally, merchant server 140 may be maintained by anyone or any entity that receives money, which includes charities as well as retailers and restaurants. For example, a purchase transaction may be payment or gift to an individual. Merchant server 140 may include a database 145 identifying available products and/or services (e.g., collectively referred to as items) which may be made available for viewing and purchase by user 105. Accordingly, merchant server 140 also may include a marketplace application 150 which may be configured to serve information over network 360 to browser 115 of user device 110. In one embodiment, user 105 may interact with marketplace application 150 through browser applications over network 160 in order to view various products, food items, or services identified in database 145.

Merchant server 140 also may include a checkout application 155 which may be configured to facilitate the purchase by user 105 of goods or services online or at a physical POS or store front. Checkout application 155 may be configured to accept payment information from or on behalf of user 105 through trusted party server 170 over network 160. For example, checkout application 155 may receive and process a payment confirmation from trusted party server 170, as well as transmit transaction information to the trusted party and receive information from the trusted party (e.g., a transaction ID). Checkout application 155 may be configured to receive payment via a plurality of payment methods including cash, credit cards, debit cards, checks, money orders, or the like.

In some embodiments, the merchant server 140 is a part of, or is maintained by, an identity platform. An identity platform is a platform on which a consumer can establish and maintain an identity. The consumer's identity may include, but is not limited to, the consumer's real name, shipping address, billing address, phone number(s), email address, account username, account password, account settings or preferences, funding instrument information (e.g., credit card number, debit card number, checking or savings account information), all or parts of a social security number, date of birth, mother's maiden name, etc. At least some of the identity information of the user may be sensitive in nature and should be protected. In some embodiments, the identity platforms may include a social network, such as Facebook®, Google® (e.g., via Google Plus®), YouTube®, Twitter®, Pinterest®, etc. In other embodiments, the identity platforms may include a hardware/software company such as Apple®, Microsoft®, Sony®, etc. In yet other embodiments, the identity platforms may include traditional retailers such as Macy's®, Sear's®, Walmart®, etc. Thus, an identity platform may be part of or managed by a merchant or merchant server or separate from the merchant or merchant server.

Trusted party server 170 may be maintained, for example, by an online payment service provider which may provide payment between user 105 and the operator of merchant server 140. In this regard, trusted party server 170 may include one or more payment applications 175 which may be configured to interact with user device 110 and/or merchant server 140 over network 160 to facilitate the purchase of goods or services, communicate/display information, and send payments by user 105 of user device 110.

Trusted party server 170 also maintains a plurality of user accounts 180, each of which may include account information 185 associated with consumers, merchants, and funding sources, such as credit card companies. For example, account information 185 may include private financial information of users of devices such as account numbers, passwords, device identifiers, usernames, phone numbers, credit card information, bank information, or other financial information which may be used to facilitate online transactions by user 105. Account information may also include user purchase history and user ratings. Advantageously, payment application 175 may be configured to interact with merchant server 140 on behalf of user 105 during a transaction with checkout application 155 to track and manage purchases made by users and which and when funding sources are used. In some embodiments, an identity platform may be managed by or be part of a trusted party service, such as trusted party server 170, or be a separate entity or service provider that manages identity.

A transaction processing application 190, which may be part of payment application 175 or separate, may be configured to receive information from a user device and/or merchant server 140 for processing and storage in a payment database 195. Transaction processing application 190 may include one or more applications to process information from user 105 for processing an order and payment using various selected funding instruments, including for initial purchase and payment after purchase as described herein. As such, transaction processing application 190 may store details of an order from individual users, including funding source used, credit options available, etc. Payment application 175 may be further configured to determine the existence of and to manage accounts for user 105, as well as create new accounts if necessary.

In one embodiment, trusted party server 170 may include a token vault storing various information on token formats, conventions, data, and the like. For example, a token may be generated for a user's payment account to allow payment transactions using the token. A user's identity information, preferences, or other information may be stored and associated with the user's account and mapped to tokens. Merchant accounts at the trusted party server 170 also may store merchant's information, such as type of merchant, product or service offered, method of payments, and the like to ensure diversified use of tokens that may vary by merchant type/service etc.

Payment network 172 may be operated by payment card service providers or card associations, such as DISCOVER, VISA, MASTERCARD, AMERICAN EXPRESS, RuPAY, China Union Pay, etc. The payment card service providers may provide services, standards, rules, and/or policies for issuing various payment cards. A network of communication devices, servers, and the like also may be established to relay payment related information among the different parties of a payment transaction.

Issuer host 168 may be a server operated by an issuing bank or issuing organization of payment cards. The issuing banks may enter into agreements with various merchants to accept payments made using the payment cards. The issuing bank may issue a payment card to a user after a card account has been established by the user at the issuing bank. The user then may use the payment card to make payments at various merchants who agreed to accept the payment card.

Acquirer host 165 may be a server operated by an acquiring bank. An acquiring bank is a financial institution that accepts payments on behalf of merchants. For example, a merchant may establish an account at an acquiring bank to receive payments made via various payment cards. When a user presents a payment card as payment to the merchant, the merchant may submit the transaction to the acquiring bank. The acquiring bank may verify the payment card number, the transaction type and the amount with the issuing bank and reserve that amount of the user's credit limit for the merchant. An authorization will generate an approval code, which the merchant stores with the transaction.

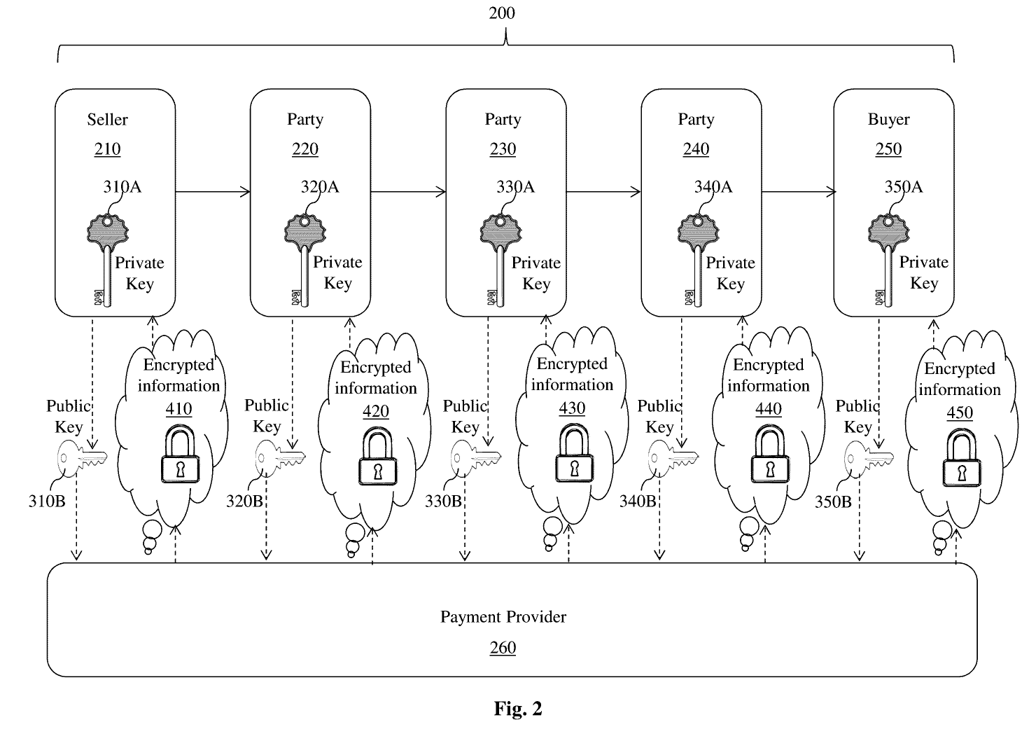

FIG. 2 illustrates a simplified diagram of an example transactional chain 200 in accordance with an embodiment of the present disclosure. An example electronic transaction is conducted via the transactional chain 200 to illustrate the concepts of the present disclosure, though it is understood that the concepts of the present disclosure may also apply to other electronic transactions in which the participants do not necessarily form a transactional chain.

Referring to FIG. 2, the transactional chain 200 includes a seller 210, a plurality of parties 220, 230, and 240, and a buyer 250. The parties 220, 230, and 240 perform tasks to ensure that a successful transaction is completed between the seller 210 and the buyer 250. In one example embodiment, the seller 210 is a merchant who has offered one or more items for sale online, for example the merchant that is offering merchandise through the merchant server 140 in FIG. 1. The buyer 250 is a consumer (either an individual or a business entity such as a company) who has purchased one or more items from the seller 210. For example, the buyer 250 may be the user 105 in FIG. 1. The purchasing transaction is handled by a trusted party 260, for example the trusted party hosting the trusted party server 170 in FIG. 1. In some embodiments, the trusted party 260 is a third party payment provider. In other embodiments, the trusted party 260 is a party that provides privacy in a non-payment context.

As one example, the parties 220/230/240 are parties that handle the shipping of the items purchased by the buyer 250. The party 220 may be the party that picks up the item to be shipped from the home of seller 210, or the party 220 may be the party that picks up the item to be shipped from a post office or the office of another commercial shipping company such as Fedex® or UPS®, where the seller 210 has dropped off the item to be shipped. The party 220 drops off the item to be shipped at a first airport (or a train station or bus station) close to the seller 210. The party 230 may be the party that transports the item from a first airport (or a train station or bus station) to a second airport (or a train station or bus station) that is close to the buyer 250. The party 240 may be the party that takes the item from the second airport (or a train station or bus station) to the home of the buyer 250.

In some embodiments, the parties 220, 230, and 240 are all employees of a shipping company such as Fedex®, UPS®, DHL®, or even the United States Post Office (USPS). In other embodiments, one or more of the parties 220, 230, and 240 may be outsourced contractors who are not employees of the shipping company. It is also understood that in alternative embodiments, there may be more (or fewer) parties on the transaction chain 200 than the parties 220-240 illustrated in FIG. 2, and that each party may perform tasks different than what is discussed above, as long as the purchased items can be successfully shipped from the seller 210 to the buyer 250.

In the illustrated embodiment, the trusted party 260 has all the information related to the transaction between the seller 210 and the buyer 250. However, as discussed above, it may not be desirable to give all the participants in the chain 200 access to the transactional information in its entirety. For example, the seller 210 may need to know that a payment for the purchased item has been made, or when or how fast the purchased item needs to be shipped out, but the seller 210 does not need to know who the buyer 250 is, or his specific payment-related information (since the trusted party 260 is handling the payment for the transaction), or even the buyer 250's shipping address. The party 220 may only need to know the seller 210's address (or the location that the item was dropped off by the seller 210) and also which airport it needs to take the purchased item to be shipped out, but it does not need to know the shipping address of the buyer 250. The party 230 may only need to know the airport that the purchased item needs to be sent to, but it does not need to know anything about the seller 210 or the buyer 250, including their respective addresses. The party 240 may only need to know the address of the buyer 250, but it does not need to know where the purchased item came from, or anything about the seller 210. Lastly, the buyer 250 may need to know the purchased item's price and condition and how to pay for the item, but does not need to know the seller 210's address or how the seller's shipping methods, or the exact route the purchased item undertook in being shipped to the buyer 250.

It is understood that the various aspects of the transaction that should be visible to each of the participants (e.g., the seller 210, the parties 220/230/240, and the buyer 250) on the chain 200 may differ from embodiment to embodiment. In some embodiments, the trusted party 260 determines what portion of the transactional information should be made visible to each of the participants on the chain 200. For example, based on the transaction logistics, the trusted party may analyze the tasks that are performed by each participant on the chain 200, and based on the analysis, it may determine what information is absolutely necessary for each task to be performed. The trusted party 260 breaks down the transactional information into the different pieces (or portions) accordingly, and the party performing that task is then given privilege to view that piece of information, and only that piece of information. In other examples, the trusted party 260 may prompt the participants on the chain 200 to state which pieces of information are absolutely required for that party to perform its intended task. Based on the feedback from the participants, the trusted party 260 breaks down the transactional information into the different pieces accordingly, and each party is given privilege to be able to only view the piece of transactional information that it deems absolutely necessary to perform its intended task. In another embodiment, specific users may designate what information can be shared and with which recipient(s), even if certain information is not needed by the receiving party(s). In these manners described above, the various participants of the transaction are given selective visibility of different portions of the transactional information.

According to the various aspects of the present disclosure, the selective visibility of different portions of the transactional information to each of the participants along the chain 200 is implemented by electronic cryptography, for example by encrypting and decrypting information using public/private keys. As shown in FIG. 2, the seller 210, the parties 220, 230, and 240, and the buyer 250 each have a respective private key 310A/320A/330A/340A/350A, as well as a respective corresponding public key 310B/320B/330B/340B/350B. Each private key is mathematically uniquely associated with its corresponding public key. In some embodiments, the private keys 310A/320A/330A/340A/350A and the public keys 310B/320B/330B/340B/350B each include a long number. For example, a public key (or a private key) may be: F732 0741 00C9 18FA CA8D EB2D EFD5 FA37 82B9 E069 EA97 FC20 5E35 F577 EE31 C4FB C6E4 4811 7D46 BC85 B3FA 362F 922B F01B 2F40 C744 2654 C0DD 2881 D673 CA2B 4003 C266 E2CD CB02 2401 37A6, where the numbers are in hexadecimal form. A private key is also a large number that is mathematically related to the public key, for example based on integer factorization, discrete logarithm, or elliptic curve relationships. Because of their unique mathematical relationship, a message encrypted by a public key can only be decrypted by the corresponding private key.

In some embodiments, the public key and its corresponding private key are generated together as a key pair by a key generation program. The public/private key pairs may be provided to the seller 210, the buyer 250, or the parties 220/230/240 by the trusted party 260. Alternatively, the seller 210, the buyer 250, or the parties 220/230/240 may each generate their own public/private key pairs. Furthermore, or one or more other entities may generate the key pairs for the seller 210, the buyer 250, or the parties 220/230/240. For example, a shipping company that is in charge of the parties 220, 230, and 240 may generate their private/public key pairs.

As the name suggests, the public keys 310B/320B/330B/340B/350B are openly available to members of the general public. In the illustrated embodiment, the public keys 310B/320B/330B/340B/350B are freely obtained by the trusted party 260. The trusted party 260 then identifies the portion of the transactional information that should be made selectively visible to each of the participants along the chain 200 and encrypts that portion of the transactional information with the participant's respective public key. The encrypted portion of the transactional information is then sent back to their respective participants along the chain 200. It is also understood that homomorphic encryption algorithms may be used to carry out the encryption in some embodiments.

In the example discussed herein, the trusted party 260 sends encrypted information 410 (encrypted with the public key 310B from the seller 210) back to the seller 210. As discussed above, the encrypted information 410 may contain information regarding the successful payment of the purchased item and when (or how fast) the item needs to be shipped out. However, since the encrypted information 410 is encrypted with the public key 310B of the seller 210, only the seller 210 can decrypt the encrypted information 410 with the private key 310A. Thus, the parties 220/230/240 or the buyer 250 cannot view the underlying message contained in the encrypted information 410.

The trusted party 260 sends encrypted information 420 (encrypted with the public key 320B from the party 220) back to the party 220. As discussed above, the encrypted information 420 may contain information regarding the seller 210's address (or the address of the place where the seller has dropped off the item to be shipped) and also which airport it needs to take the purchased item to be shipped out. However, since the encrypted information 420 is encrypted with the public key 320B of the party 220, only the party 220 can decrypt the encrypted information 420 with the private key 320A. Thus, the seller 210, the parties 230/240, or the buyer 250 cannot view the underlying message contained in the encrypted information 420.

The trusted party 260 sends encrypted information 430 (encrypted with the public key 330B from the party 230) back to the party 230. As discussed above, the encrypted information 430 may contain information regarding the airport to which the purchased item needs to be sent. However, since the encrypted information 430 is encrypted with the public key 330B of the party 230, only the party 230 can decrypt the encrypted information 430 with the private key 330A. Thus, the seller 210, the parties 220/240, or the buyer 250 cannot view the underlying message contained in the encrypted information 430.

The trusted party 260 sends encrypted information 440 (encrypted with the public key 340B from the party 240) back to the party 240. As discussed above, the encrypted information 440 may contain information regarding the address of the buyer 250. However, since the encrypted information 440 is encrypted with the public key 340B of the party 240, only the party 240 can decrypt the encrypted information 440 with the private key 340A. Thus, the seller 210, the parties 220/230, or the buyer 250 cannot view the underlying message contained in the encrypted information 440.

The trusted party 260 sends encrypted information 450 (encrypted with the public key 350B from the party 250) back to the buyer 250. As discussed above, the encrypted information 450 may contain information regarding the purchased item's price and condition and how to pay for the item. However, since the encrypted information 450 is encrypted with the public key 350B of the buyer 250, only the buyer 250 can decrypt the encrypted information 450 with the private key 350A. Thus, the seller 210 or the parties 220/230/240 cannot view the underlying message contained in the encrypted information 450.

Using their respective private keys 310A/320A/330A/340A/350A, the seller 210, the parties 220/230/240, and the buyer 250 decrypt the encrypted information 410/420/430/440/450, respectively. In various embodiments, the decryption may be performed using hardware devices such as servers, personal desktop computers, laptop computers, smartphones, tablet computers, or even custom-made machines (e.g., cockpit panel of an aircraft). In various embodiments, one or more of the hardware devices may be implemented as embodiments of the user device 110 of FIG. 1 or the merchant server 140 of FIG. 1. The trusted party 260 may facilitate the decryption by sending the encrypted information to their respective recipients, along with other relevant information (such as information informing the recipient as to what the encrypted information is for). Once decrypted, the different portions of the transactional information may be displayed on the various hardware devices of the participants discussed above.

It can be seen that the electronic cryptography scheme implemented herein offers advantages over conventional transactions. It is understood, however, that not all advantages are necessarily disclosed herein, different embodiments may offer different advantages, and that no particular advantage is required for all embodiments. One advantage is improved security. Unlike conventional transactions where different participants along the chain can see some (or all) of the transactional information that is not required for that participant to perform their task, the present disclosure uses cryptography to restrict the visibility of the different aspects of the transactional information to only parties that need them, while hiding the remaining aspects of the transactional information from other participants. This approach reduces unnecessary exposure of sensitive (or potentially sensitive) information, which in turn minimizes risks of fraud pertaining to the transaction. Furthermore, the selective cryptography of the present disclosure not only improves user satisfaction (e.g., due to the reduction of fraud), but also improves the functioning of the system itself. This is because: 1. the data transmission is more secure as a result of the data encryption; and 2. the fact that each participant only needs to receive a portion of the transactional information (e.g., the respective encrypted information) results in a reduction of the total amount of transmitted data, which frees up system resources and communication bandwidth.

It is understood that although a shipping transaction is used as an example to illustrate certain concepts of the present disclosure, the concepts of the present disclosure may apply to other suitable types of transactions. In one embodiment, the transaction may be an electronic financial transaction in which each of the participants may have to process a respective aspect of the transaction (e.g., verifying a certain portion of it or performing another task based on it). For example, instead of offering items for sale, the “seller 210” may be a sender (or generator) of an electronic document, and instead of purchasing the items, the “buyer 250” may be a target recipient of the electronic document. The “seller” 210 sends the electronic document to the party 220, which processes a portion of the electronic document and then sends the processed electronic document to the party 230. The party 230 processes another portion of the electronic document and then sends the processed electronic document to the party 240. The party 240 processes yet another portion of the electronic document and then sends the processed electronic document to the “buyer” 250. In this example, the trusted party 260 may encrypt the respective portions of the electronic document processed by the parties 220/230/240 (and possibly processed even by the sender/generator 210 of the document) by their respective public keys. The encrypted information is then sent back to the respective parties to be decrypted using the corresponding private keys. Again, the same benefits discussed above with respect to the shipping example may be obtained in the electronic transaction scenario too, for example benefits related to reduced fraud, enhanced security, and improved performance of the system.

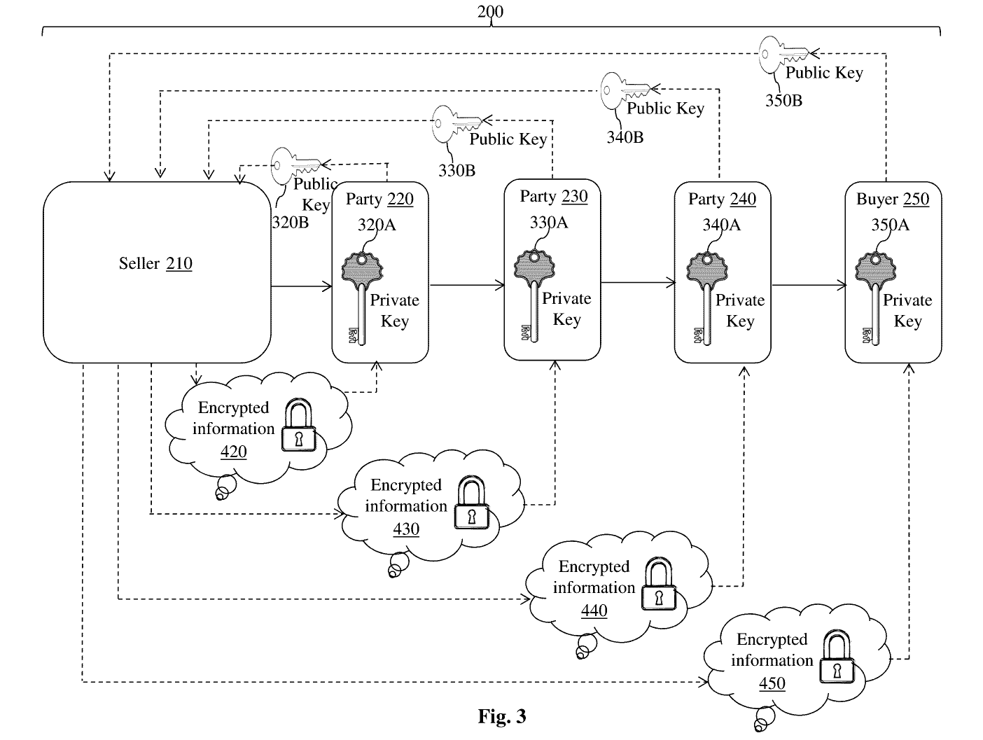

The discussions above with reference to FIG. 2 involve an embodiment where the trusted party 260 determines the respective viewing privileges for all the participants of the transaction and encrypts the different portions of the transactional information accordingly. In comparison, FIG. 3 illustrates an alternative embodiment where one of the participants of the transaction determines the respective viewing privileges for the remaining participants of the transaction and performs the encryption accordingly. For reasons of consistency and clarity, similar elements appearing in FIGS. 2 and 3 are labeled the same. Furthermore, although the trusted party 260 is not specifically illustrated in FIG. 3, it is understood that it may still be used to handle the financial aspects of the transaction.

Referring to FIG. 3, the transaction chain 200 includes the seller 210, the parties 220, 230, 240, and the buyer. The seller 210 and the buyer 250 engage in an electronic transaction, and the parties 220, 230, and 240 help facilitate the transaction. For example, ad discussed above with reference to FIG. 1, the parties 220, 230, and 240 may be members (or contractors) of a shipping company that ships the purchased item from the seller 210 to the buyer 250, or alternatively, the parties 220-240 may process different portions of an electronic document sent from the seller 210 to the buyer 250.

The seller 210 determines the respective viewing privileges for the parties 220, 230, and 240 regarding the transactional information. In some embodiments, the seller 210 also determines the viewing privilege of the buyer 250. The parties 220, 230, 240 and the buyer 250 provide their respective public keys 320A, 330A, 340A, and 350A to the seller 210. Using the public key 320B, the seller 210 encrypts a portion of the transactional information that the party 220 needs to know in order to perform its task, and the seller 210 sends the encrypted information 420 to the party 220. Using the public key 330B, the seller 210 encrypts a portion of the transactional information that the party 230 needs to know in order to perform its task, and the seller 210 sends the encrypted information 430 to the party 230. Using the public key 340B, the seller 210 encrypts a portion of the transactional information that the party 240 needs to know in order to perform its task, and the seller 210 sends the encrypted information 440 to the party 240. In embodiments where the buyer 250 has limited viewing privileges of the transactional information, the seller 210 also uses the public key 350B to encrypt a portion of the transactional information that it deems the buyer 250 can view, and the seller 210 sends the encrypted information 450 to the buyer 250.

The party 220 decrypts the encrypted information 420 with the private key 320A that is paired to the public key 320B. As such, the party 220 is able to view only the underlying message contained in the encrypted information 420. The party 230 decrypts the encrypted information 430 with the private key 330A that is paired to the public key 330B. As such, the party 230 is able to view only the underlying message contained in the encrypted information 430. The party 240 decrypts the encrypted information 440 with the private key 340A that is paired to the public key 340B. As such, the party 240 is able to view only the underlying message contained in the encrypted information 440. The buyer 250 decrypts the encrypted information 450 with the private key 350A that is paired to the public key 350B. As such, the buyer 250 is able to view only the underlying message contained in the encrypted information 450. Again, the electronic cryptography scheme of FIG. 3 offers the same benefits as those discussed above in association with FIG. 2, for example benefits related to reduction of fraud, etc.

It is also understood that although seller 210 was used as an example in FIG. 3 to illustrate how a participant of the electronic transaction can set the viewing privileges for other participants and also perform encryption, this may be performed by other participants of the electronic transaction in alternative embodiments.

It is also understood that although the embodiments discussed above in association with FIGS. 2-3 involve using asymmetric cryptography to restrict access to different parts of the transaction information to different parties, symmetric cryptography may be implemented to accomplish the same tasks in other embodiments. For example, instead of each of the participants of the transaction having an asymmetric public/private key pair, each participant may have a symmetric key pair. The symmetric key pair may be used to encrypt and decrypt transaction information. Each participant may have its own unique symmetric key pair different than other participants. In this manner, a participant of the transaction may still only be able to decrypt a portion of the transaction information that is meant for that party, and not be able to decrypt the rest of the transaction information that is meant for other participants. In some embodiments, the symmetric cryptography may include a homomorphic encryption scheme that uses a master key+derived keys. Other suitable symmetric cryptography techniques may also be used but are not specifically discussed in detail herein for reasons of simplicity.

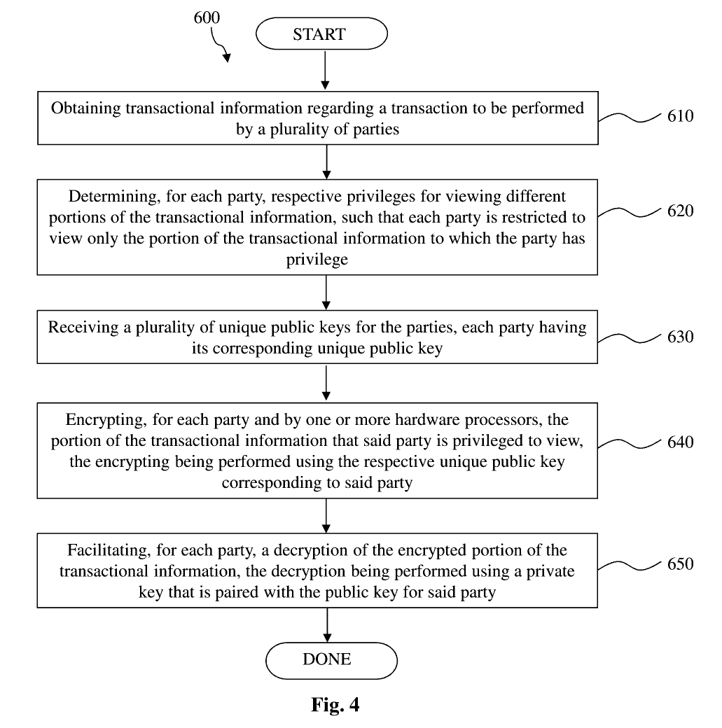

FIG. 4 is a flowchart illustrating a method 600 of performing electronic cryptography according to various aspects of the present disclosure. The method 600 may be performed by one or more hardware processors.

The method 600 includes a step 610 of obtaining transactional information regarding a transaction to be performed by a plurality of parties. In some embodiments, the transaction is performed by the plurality of parties sequentially along a chain. In some embodiments, the transaction includes a shipping transaction in which each party performs one or more of: receiving an item from a previous party along the chain. In some embodiments, the transaction includes an electronic transaction in which each party performs one or more of: receiving an electronic document from a previous party, processing a respective aspect of the electronic document, and sending the electronic document to a subsequent party along the chain.

The method 600 includes a step 620 of determining, for each party, respective privileges for viewing different portions of the transactional information, such that each party is restricted to view only the portion of the transactional information to which the party has privilege.

The method 600 includes a step 630 of receiving a plurality of unique public keys for the parties, each party having its corresponding unique public key.

The method 600 includes a step 640 of encrypting, for each party and by one or more hardware processors, the portion of the transactional information that said party is privileged to view. The encrypting being performed using the respective unique public key corresponding to said party. In some embodiments, the encrypting is performed by a third-party trusted party that is handling the transaction. In some other embodiments, the encrypting is performed by one of the parties performing the transaction.

The method 600 includes a step 650 of facilitating, for each party, a decryption of the encrypted portion of the transactional information, the decryption being performed using a private key that is paired with the public key for said party.

It is understood that additional method steps may be performed before, during, or after the steps 610-650 discussed above. It is also understood that one or more of the steps of the method 600 described herein may be omitted, combined, or performed in a different sequence as desired.

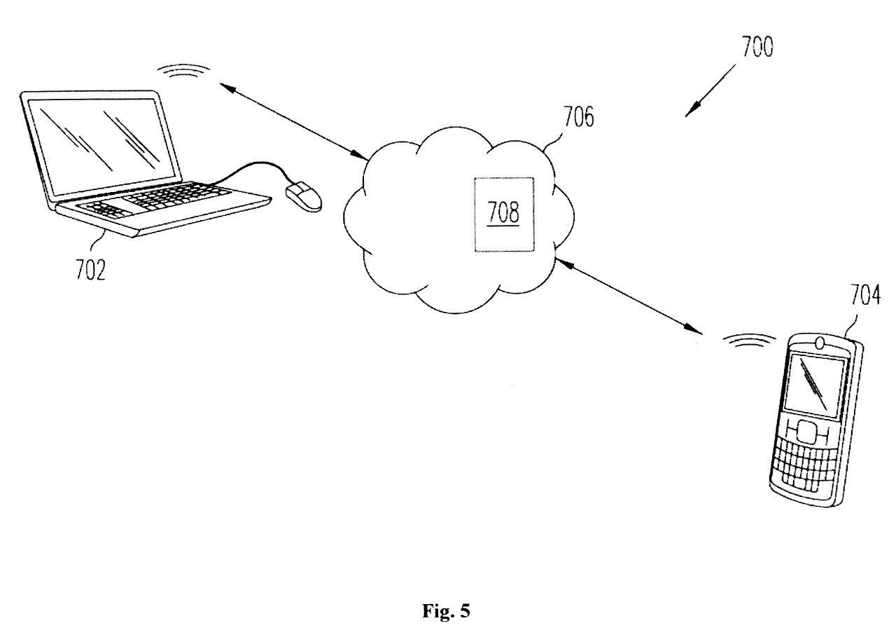

FIG. 5 illustrates an example cloud-based computing architecture 700, which may also be used to implement various aspects of the present disclosure. The cloud-based computing architecture 700 includes a mobile device 704 and a computer 702, both connected to a computer network 706 (e.g., the Internet or an intranet). In one example, a consumer has the mobile device 704, which is configured to access identity platforms and initiate purchasing transactions therethrough.

The mobile device 704 is in communication with cloud-based resources 708, which may include one or more computers, such as server computers, with adequate memory resources to handle requests from a variety of users. A given embodiment may divide up the functionality between the mobile device 704 and the cloud-based resources 708 in any appropriate manner. For example, an app on mobile device 704 may perform basic input/output interactions with the user, but a majority of the processing and caching may be performed by the cloud-based resources 708. However, other divisions of responsibility are also possible in various embodiments.

The cloud-based computing architecture 700 also includes the personal computer 702 in communication with the cloud-based resources 708. In one example, a participating merchant or consumer/user may access information from the cloud-based resources 708 by logging on to a merchant account or a user account at computer 702.

It is understood that the various components of cloud-based computing architecture 700 are shown as examples only. For instance, a given user may access the cloud-based resources 708 by a number of devices, not all of the devices being mobile devices. Similarly, a merchant or another user may access resources 708 from any number of suitable mobile or non-mobile devices. Furthermore, the cloud-based resources 708 may accommodate many merchants and users in various embodiments.

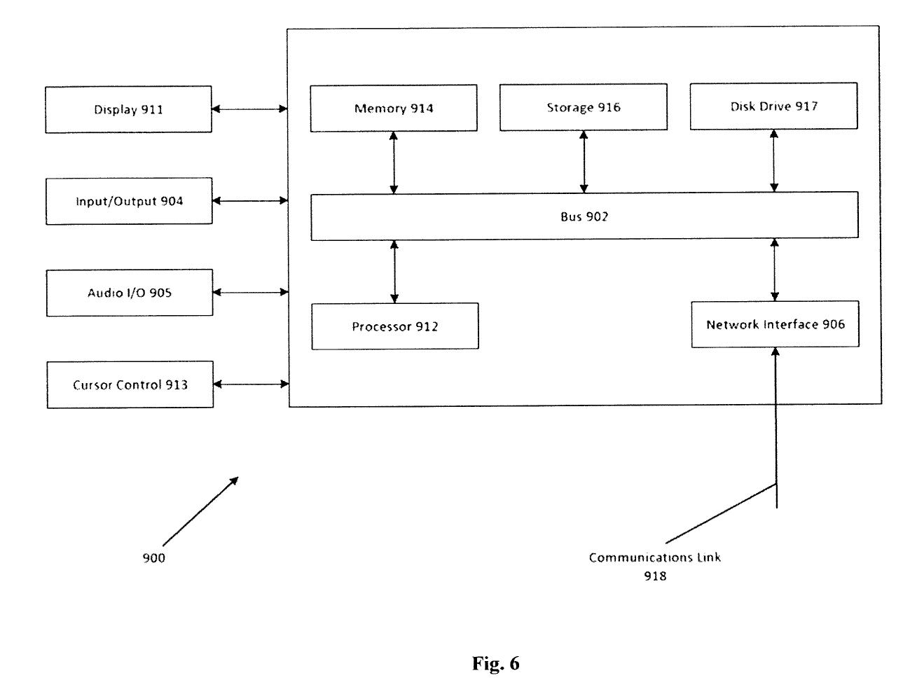

FIG. 6 is a block diagram of a computer system 900 suitable for implementing one or more embodiments of the present disclosure. For example, the computer system 900 may be used to implement the electronic cryptography discussed above in association with FIGS. 2 and 3. As such, the computer system 900 is configured to execute the steps of the method 600 discussed above in association with FIG. 4.

In various implementations, the computer system 900 may be a user device, for example a user device of any of the participants of the transaction discussed above in association with FIGS. 2-3, or a device used by the trusted party 260. The user device may comprise a personal computing device (e.g., smart phone, a computing tablet, a personal computer, laptop, wearable device, Bluetooth device, key FOB, badge, etc.) capable of communicating with a network. The merchant and/or trusted party may utilize a network computing device (e.g., a network server) capable of communicating with the network. It should be appreciated that each of the devices utilized by users, merchants, and trusted parties may be implemented as computer system 900 in a manner as follows.

Computer system 900 includes a bus 902 or other communication mechanism for communicating information data, signals, and information between various components of computer system 900. Components include an input/output (I/O) component 904 that processes a user action, such as selecting keys from a keypad/keyboard, selecting one or more buttons or links, etc., and sends a corresponding signal to bus 902. I/O component 904 may also include an output component, such as a display 911 and a cursor control 913 (such as a keyboard, keypad, mouse, etc.). An optional audio input/output component 905 may also be included to allow a user to use voice for inputting information by converting audio signals. Audio I/O component 905 may allow the user to hear audio. A transceiver or network interface 906 transmits and receives signals between computer system 900 and other devices, such as another user device, a merchant server, or a trusted party server via network 360. In one embodiment, the transmission is wireless, although other transmission mediums and methods may also be suitable. A processor 912, which can be a micro-controller, digital signal processor (DSP), or other processing component, processes these various signals, such as for display on computer system 900 or transmission to other devices via a communication link 918. Processor 912 may also control transmission of information, such as cookies or IP addresses, to other devices.

Components of computer system 900 also include a system memory component 914 (e.g., RAM), a static storage component 916 (e.g., ROM), and/or a disk drive 917. Computer system 900 performs specific operations by processor 912 and other components by executing one or more sequences of instructions contained in system memory component 914. Logic may be encoded in a computer readable medium, which may refer to any medium that participates in providing instructions to processor 912 for execution. Such a medium may take many forms, including but not limited to, non-volatile media, volatile media, and transmission media. In various implementations, non-volatile media includes optical or magnetic disks, volatile media includes dynamic memory, such as system memory component 914, and transmission media includes coaxial cables, copper wire, and fiber optics, including wires that comprise bus 902. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 900. In various other embodiments of the present disclosure, a plurality of computer systems 900 coupled by communication link 918 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

One aspect of the present disclosure involves a system. The system includes an electronic memory storing programming instructions; and one or more electronic processors in communication with the electronic memory. The one or more electronic processors are configured to execute the programming instructions to perform the following steps: obtaining transactional information regarding a transaction to be performed by a plurality of parties; determining, for each party, respective privileges for viewing different portions of the transactional information, such that each party is restricted to view only the portion of the transactional information to which the party has privilege; receiving a plurality of unique public keys for the parties, each party having its corresponding unique public key; and encrypting, for each party and by one or more hardware processors, the portion of the transactional information that said party is privileged to view, the encrypting being performed using the respective unique public key corresponding to said party.

Another aspect of the present disclosure involves a method of performing electronic cryptography. The method includes: receiving indications of a first party and a second party each requesting access to transaction information pertaining to a transaction, the transaction information comprising a first portion of the transaction information encrypted using a first public key and a second portion of the transaction information encrypted using a second public key; facilitating, for the first party, a decryption of the first portion of the transaction information, the decryption being performed using a first private key paired with the first public key associated with the first party; and facilitating, for the second party, a decryption of the second portion of the transaction information, the decryption being performed using a second private key paired with the second public key associated with the second party.

Yet another aspect of the present disclosure involves a non-transitory machine-readable medium having stored thereon machine-readable instructions executable to cause a machine to perform operations comprising: obtaining transactional information regarding a transaction to be performed by a plurality of parties; determining, for each party, respective privileges for viewing different portions of the transactional information, such that each party is restricted to view only the portion of the transactional information to which the party has privilege; receiving a plurality of unique public keys for the parties, each party having its corresponding unique public key; and encrypting, for each party and by one or more hardware processors, the portion of the transactional information that said party is privileged to view, the encrypting being performed using the respective unique public key corresponding to said party.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system for performing electronic cryptography, comprising:
a non-transitory memory storing instructions; and
one or more hardware processors coupled to the non-transitory memory and configured to read instructions from the non-transitory memory to cause the system to perform operations comprising:
obtaining transactional information regarding a transaction to be performed by a plurality of parties;
determining, for each party, respective privileges for viewing different portions of the transactional information, such that each party is restricted to view only the portion of the transactional information to which the party has privilege;
receiving a plurality of unique public keys for the parties, each party having its corresponding unique public key; and
encrypting, for each party and by one or more hardware processors, the portion of the transactional information that said party is privileged to view, the encrypting being performed using the respective unique public key corresponding to said party.

2. The system of claim 1, wherein the operations further comprise: facilitating, for each party, a decryption of the encrypted portion of the transactional information, the decryption being performed using a private key that is paired with the public key for said party.

3. The system of claim 1, wherein the transaction is performed by the plurality of parties sequentially along a chain.

4. The system of claim 3, wherein the transaction includes a shipping transaction in which each party performs one or more of: receiving an item from a previous party along the chain.

5. The system of claim 3, wherein the transaction includes an electronic transaction in which each party performs one or more of: receiving an electronic document from a previous party, processing a respective aspect of the electronic document, and sending the electronic document to a subsequent party along the chain.

6. The system of claim 1, wherein the encrypting is performed by a trusted party that is handling the transaction.

7. The system of claim 1, wherein the encrypting is performed by one of the parties performing the transaction.

8. A method of performing electronic cryptography, comprising:
receiving indications of a first party and a second party each requesting access to transaction information pertaining to a transaction, the transaction information comprising a first portion of the transaction information encrypted using a first public key and a second portion of the transaction information encrypted using a second public key;
facilitating, for the first party, a decryption of the first portion of the transaction information, the decryption being performed using a first private key paired with the first public key associated with the first party; and
facilitating, for the second party, a decryption of the second portion of the transaction information, the decryption being performed using a second private key paired with the second public key associated with the second party.

9. The method of claim 8, further comprising: receiving the first public key from the first party and the second public key from the second party.

10. The method of claim 8, further comprising:
receiving, by the first party, a privilege for viewing only the first portion of the transaction information; and
receiving, by the second party, a privilege for viewing only the second portion of the transaction information.

11. The method of claim 8, further comprising: before the facilitating the decryption of the first portion and the second portion of the transaction information, encrypting the first portion of the transaction information with the first public key and encrypting the second portion of the transaction information with the second public key.

12. The method of claim 11, wherein the encrypting the first portion and the encrypting the second portion of the transaction information are performed by a trusted party.

13. The method of claim 8, wherein the first party and the second party are sequential participants of the transaction.

14. The method of claim 8, wherein the transaction comprises a shipping transaction in which the first party and the second party each perform a shipping task with respect to an item of the shipping transaction.

15. The method of claim 8, wherein the transaction comprises a financial transaction in which the first party and the second party each process a respective portion of an electronic document of the financial transaction.

16. A non-transitory machine-readable medium having stored thereon machine-readable instructions executable to cause a machine to perform operations comprising:
obtaining transactional information regarding a transaction to be performed by a plurality of parties;
determining, for each party, respective privileges for viewing different portions of the transactional information, such that each party is restricted to view only the portion of the transactional information to which the party has privilege;
receiving a plurality of unique public keys for the parties, each party having its corresponding unique public key; and
encrypting, for each party and by one or more hardware processors, the portion of the transactional information that said party is privileged to view, the encrypting being performed using the respective unique public key corresponding to said party; and
facilitating, for each party, a decryption of the encrypted portion of the transactional information, the decryption being performed using a private key that is paired with the public key for said party.

17. The non-transitory machine-readable medium of claim 16, wherein the transaction is performed by the plurality of parties sequentially along a chain.

18. The non-transitory machine-readable medium of claim 17, wherein the transaction includes a shipping transaction in which each party performs one or more of: receiving an item from a previous party along the chain.

19. The non-transitory machine-readable medium of claim 17, wherein the transaction includes an electronic transaction in which each party performs one or more of: receiving an electronic document from a previous party, processing a respective aspect of the electronic document, and sending the electronic document to a subsequent party along the chain.

20. The non-transitory machine-readable medium of claim 16, wherein the encrypting is performed by a trusted party that is handling the transaction, or by one of the parties performing the transaction.
